(19) United States
(12) Patent Application Publication
(10) Pub. No.: US 2022/0318589 A1
(43) Pub. Date: Oct. 6, 2022

(54) METHODS AND SYSTEMS OF A TAMPER-EVIDENT SEAL

(71) Applicants: PAUL ABNER, MUMBAI (IN); GANDHI DARSHAN DHRUVA, MUMBAI (IN); NATHANI MURAD, MUMBAI (IN); KAMAT DATTAPRASAD NARAYAN, MUMBAI (IN)

(72) Inventors: PAUL ABNER, MUMBAI (IN); GANDHI DARSHAN DHRUVA, MUMBAI (IN); NATHANI MURAD, MUMBAI (IN); KAMAT DATTAPRASAD NARAYAN, MUMBAI (IN)

(21) Appl. No.: 17/219,786

(22) Filed: Mar. 31, 2021

(51) Int. Cl. G06K 19/077; G06K 19/07; H04W 4/80

(52) U.S. Cl. CPC G06K 19/07798; G06K 19/0723; H04W 4/80

(57) ABSTRACT

In one aspect, a tamper-evident seal assembly includes a flag post. The flag post includes a frame configured to securely support a circuit, the circuit comprising a tamper detection chip, a pair of conducting elements comprising two (2) corresponding terminals, the terminals being exposed out of the frame. A pedestal is configured to lockingly receive a portion of the flag post for sealing an arrangement to be sealed. The pedestal encloses a conductive sticker configured to attach with the terminals of the conducting elements on locking of the flag post into the pedestal, thereby forming an electrical tamper loop with the tamper detection chip. The conductive sticker is configured to become damaged when the tamper-evident seal assembly is tampered with, causing the tamper loop to open.

### FIELD OF INVENTION

The present disclosure relates generally to the field of security systems. More particularly, the present disclosure relates to tamper-evident seals.

### BACKGROUND

Conventional NFC/RFID or dual frequency NFC plus RFID (NFC+RFID) security tags use the technology of inductive coupling, which is a phenomenon in which energy is transferred through a shared magnetic field between an RFID tag and an RFID reader. The RFID reader uses magnetic induction to create a radio-wave field that the RFID tag detects. Therefore, when a tag is placed in close proximity to the reader, the field from the antenna coil of the reader couples with the antenna coil of the tag and induces a voltage in the tag, which is then rectified and used for powering the internal circuitry of the tag. Existing passive RFID security tags/seals are capable of checking and recording the status of the tamper loop only in presence of a radio frequency (RF) field of the RFID reader. Such chips derive their power from the RF field to send a pulse around the tamper loop. If the pulse is successfully sent and received by the RF reader, a tamper check flag is set as non-tampered and seal is declared non-tampered. In the absence of such an RF field, a skilled counterfeiter can open and close the tag/seal without changing the status of the tamper check flag. Hence, under such a condition, when an RFID reader reads the tamper check flag, it will show non-tampered even though the seal/tag is tampered with, which is not desired. Currently available RFID bolt seals cannot distinguish between a locked and an unlocked seal. In such a scenario, an unlocked seal could be read by an unmanned RFID gateway and could be passed as a locked, untampered seal. There is, therefore, felt a need for developing a tamper-evident seal that discourages tampering and can provide three distinct states when read by an NFC/RFID reader application—unlocked, locked, and tampered.

### SUMMARY OF THE INVENTION

In one aspect, a tamper-evident seal assembly includes a flag post. The flag post includes a frame configured to securely support a circuit, the circuit comprising an NFC and/or RFID antenna, a tamper detection chip, a pair of conducting elements comprising two (2) corresponding terminals, the terminals being exposed out of the frame. A pedestal is configured to lockingly receive a portion of the flag post for sealing an arrangement to be sealed. The pedestal encloses a conductive sticker or a conducting element(s) configured to attach with the terminals of the conducting elements on locking of the flag post into the pedestal, thereby forming an electrical tamper loop with the tamper detection chip. The conductive sticker or the conducting elements may be configured to become damaged when the tamper-evident seal assembly is tampered with, causing the tamper loop to open.

In another aspect, a method for operating a tamper-evident seal assembly is provided. The method provides a flag post comprising a frame configured to securely support a circuit, the circuit comprising a tamper detection chip, a pair of conducting elements comprising two (2) corresponding terminals, the terminals being exposed out of the frame. The method provides a pedestal. With the pedestal, the method encloses a conductive sticker or the conducting elements configured to attach with the terminals. With the pedestal, the method lockingly receives a portion of the flag post for sealing an arrangement to be sealed. With the pedestal, the method encloses a conductive sticker or the conducting element(s) configured to attach with the terminals of the conducting elements on locking of the flag post into the pedestal. The method configures the conductive sticker or the conducting element(s) to become damaged when the tamper-evident seal assembly is tampered with, causing the tamper loop to open.

### BRIEF DESCRIPTION OF THE DRAWINGS

FIGS. 1-13 A-B illustrate various views of an example tamper-evident seal assembly, according to some embodiments.

FIG. 1 illustrates an example tamper-evident seal assembly, according to some embodiments.

FIG. 2 illustrates an example tamper-evident seal assembly, according to some embodiments.

FIG. 3 illustrates an example tamper-evident seal assembly, according to some embodiments.

FIG. 4 illustrates an example tamper-evident seal assembly, according to some embodiments.

FIGS. 5 a-b illustrate an example tamper-evident seal assembly, according to some embodiments.

FIG. 6 illustrates an example tamper-evident seal assembly, according to some embodiments.

FIGS. 7 a-c illustrate an example tamper-evident seal assembly, according to some embodiments.

FIGS. 8 a-b illustrate an example tamper-evident seal assembly, according to some embodiments.

FIG. 9 illustrates an example tamper-evident seal assembly, according to some embodiments.

FIGS. 10 a-b illustrate an example tamper-evident seal assembly, according to some embodiments.

FIG. 11 illustrates an example tamper-evident seal assembly, according to some embodiments.

FIG. 12 illustrates an example tamper-evident seal assembly, according to some embodiments.

FIGS. 13 a-b illustrate an example tamper-evident seal assembly, according to some embodiments.

FIG. 14 is a block diagram of a sample computing environment that can be utilized to implement various embodiments.

FIG. 15 illustrates an example process for operating a tamper-evident seal, according to some embodiments.

The Figures described above are a representative set and are not an exhaustive with respect to embodying the invention.

### DESCRIPTION

Disclosed are a system, method, and article of manufacture of a tamper-evident seal. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ an embodiment,′ ‘one example,’ or similar language means that a particular feature, structure, or characteristic described in connection with the embodiment is included in at least one embodiment, according to some embodiments. Thus, appearances of the phrases ‘in one embodiment,’ in an embodiment,′ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

When an element is referred to as being “mounted on,” “engaged to,” “connected to” or “coupled to” another element, it may be directly on, engaged, connected, or coupled to the other element.

Terms such as “inner,” “outer,” “beneath,” “below,” “lower,” “above,” “upper” and the like, may be used in the present disclosure to describe relationships between different elements as depicted from the figures.

### Definitions

Example definitions for some embodiments are now provided.

Application programming interface (API) can specify how software components of various systems interact with each other.

Bluetooth Low Energy (BLE) is a wireless personal area network technology.

Lockingly can mean in such a way as to lock.

LoRa (Long Range) is a low-power wide-area network modulation technique. LoRa is based on spread spectrum modulation techniques derived from chirp spread spectrum (CSS) technology. It is noted that LoRaWAN is one of several protocols that can define the upper layers of a LoRa network.

LoRaWAN is a cloud-based medium access control (MAC) layer protocol but acts mainly as a network layer protocol for managing communication between LPWAN gateways and end-node devices as a routing protocol.

Near-Field Communication (NFC) is a set of communication protocols for communication between two electronic devices over a distance (e.g. 4 cm (1½ in) or less, etc.). NFC can utilize a low-speed connection with a setup that can be used to bootstrap more-capable wireless connections.

Radio-frequency identification (RFID) uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data, usually an identifying inventory number, back to the reader. This number can be used to track inventory goods. There are two types of RFID tags. These can include passive tags are powered by energy from the RFID reader's interrogating radio waves. These can also include active tags are powered by a battery and thus can be read at a greater range from the RFID reader, up to hundreds of meters.

Ultrasonic welding is an industrial process whereby high-frequency ultrasonic acoustic vibrations are locally applied to workpieces being held together under pressure to create a solid-state weld. It can be used for plastics and metals, and for joining dissimilar materials.

### EXAMPLE SYSTEMS

Present systems can be used, inter alia, to provide a tamper-evident seal. Additionally, a tamper-evident seal that incorporates an NFC/RFID and/or NFC+RFID based security tag is provided. The tamper-evident seal incorporates an NFC/RFID or NFC+RFID based security tag. This can update the tamper check flag even in the absence of the field generated by an external electro-magnetic reader.

In some examples, the tamper-evident seal assembly includes a flag post and a pedestal. The flag post has a frame configured to securely support a circuit. The circuit includes a tamper detection chip, a pair of conducting elements having corresponding terminals. The terminals are exposed out of the frame. The pedestal is configured to lockingly receive a portion of the flag post for sealing the arrangement to be sealed. The pedestal encloses a conductive sticker configured to stick with the terminals of the conducting elements on locking of the flag post into the pedestal, thereby forming an electrical loop with the tamper detection chip. The conductive sticker is configured to become damaged when the tamper-evident seal assembly is tampered with, causing the tamper loop to open. Preferably, the flag post and the pedestal have a snap-locking arrangement defined between them. In an embodiment, the frame of the flag post has a groove and the pedestal encloses a locking ring configured to snap-lockingly engage with the groove. The circuit may include an electrical energy storage device. Preferably, the tamper detection chip is configured to receive electrical energy from the electrical energy storage device. The tamper detection chip includes an electronic memory. Preferably, the tamper detection chip is configured to irreversibly update information stored within the electronic memory when the tamper loop is opened. The circuit includes at least one antenna which is configured to transmit information stored within the electronic memory on being energized electromagnetically by an electromagnetic reader. Preferably, the tamper detection chip is an RFID chip or an NFC chip. In some example embodiments, other networking communication protocols can be utilized such as, inter alia: LoRaWAN or BLE for communication. In an embodiment, the frame consists of two panels which are ultrasonically welded together.

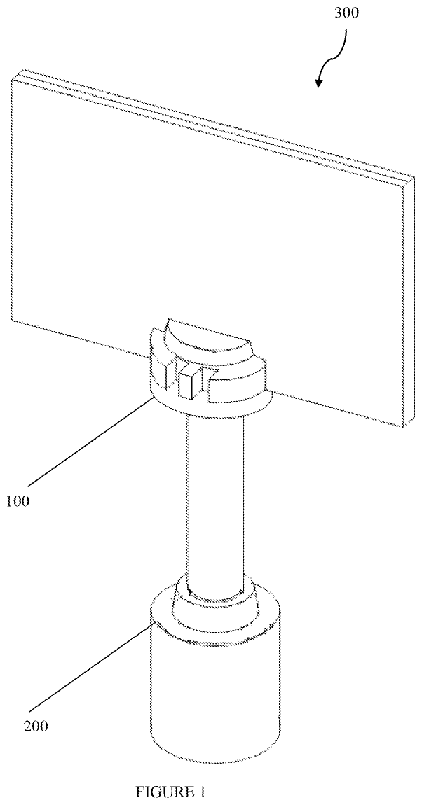

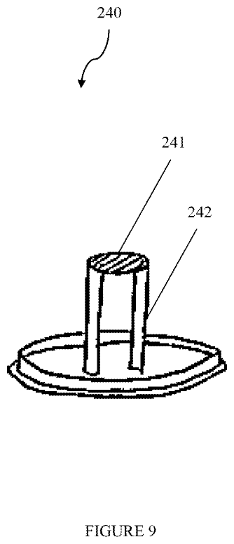

FIGS. 1-13 illustrate an example tamper-evident seal assembly 300, according to some embodiments. includes the following elements that will be discussed further infra: 100—flag post; 110—frame; 111— first panel of frame; 112— upper portion of frame; 113— recess; 114— second panel of frame; 115— pole; 116— shoulder of flag post; 120— circuit; 121— tamper detection chip; 122— antenna; 123— conducting elements; 124— terminals; 130— barrel; 131— groove; 140—over mold; 200— pedestal; 210— pedestal housing; 210a, 210b— first and second halves of pedestal housing; 230— locking ring; 220— cavity; 240— bottom cover; 241— conductive sticker; 242— sticker mount; 250— jacket; 300— tamper-evident seal assembly; etc.

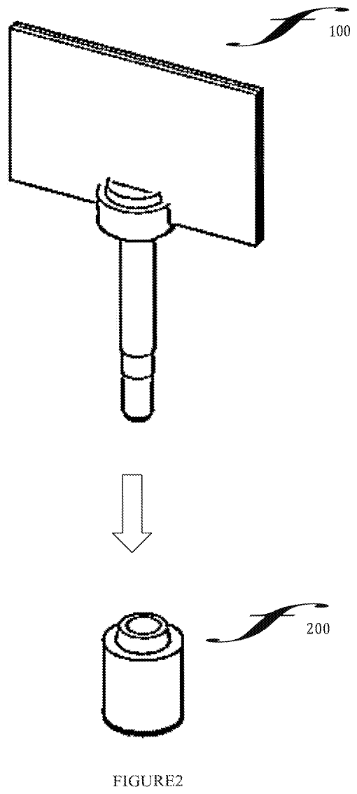

Tamper-evident seal assembly 300 can prevent any loss of items stored in cargo containers or the like, as it gets damaged beyond repair in case tampered with. The tamper-evident seal assembly 300 includes a flag post 100 and a pedestal 200, as shown in FIG. 1. The pedestal 200 is configured to receive the flag post 100, as shown in FIG. 2, and is further configured to prevent its removal by snap-locking the flap post 100.

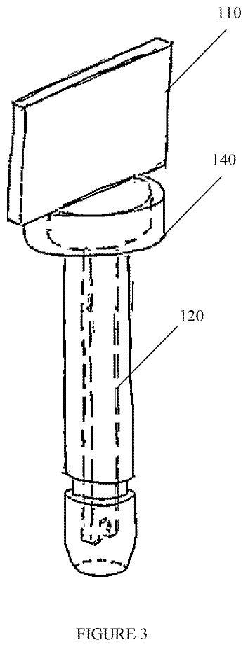

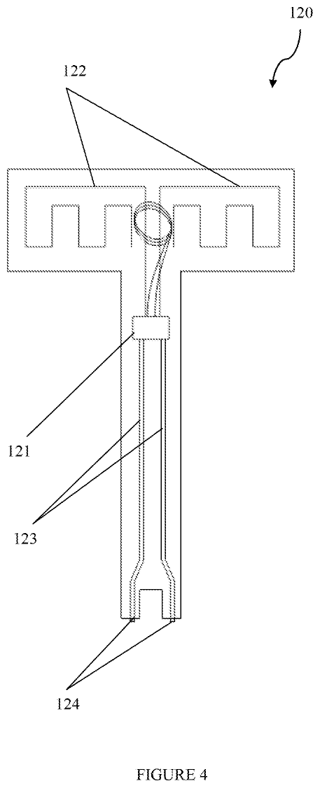

FIG. 3 shows the tamper-evident seal 300 in locked state, in accordance with preferred embodiment of the present invention. The flag post 100 is inserted through the aligned holes of the latches, e.g., to be sealed from one end and the pedestal 200 is held at the other end to receive the flag post 100. The flag post 100 is configured to enclose a circuit 120, shown in FIG. 4, wherein the circuit 120 includes comprises a tamper detection chip 121, at least one antenna 122, a pair of conducting elements 123 having corresponding terminals 124. It may have a battery and a capacitor to log any tamper attempt in the absence of a Radio frequency (RF) field.

The tamper detection chip 121 is electrically connected to the antenna 122. The tamper detection chip 121 includes a control unit, an electronic memory (memory), a tamper switch, a counter, and a comparator. The memory includes an identification register, a tamper check flag register, and a pre-determined threshold tamper value. The identification register is configured to store a unique identification code associated with the tamper indicating seal. Preferably, the chip 121 is NFC or RFID or NFC+RFID based. The circuit 120 is preferably configured in the form of a sticker or a PCB.

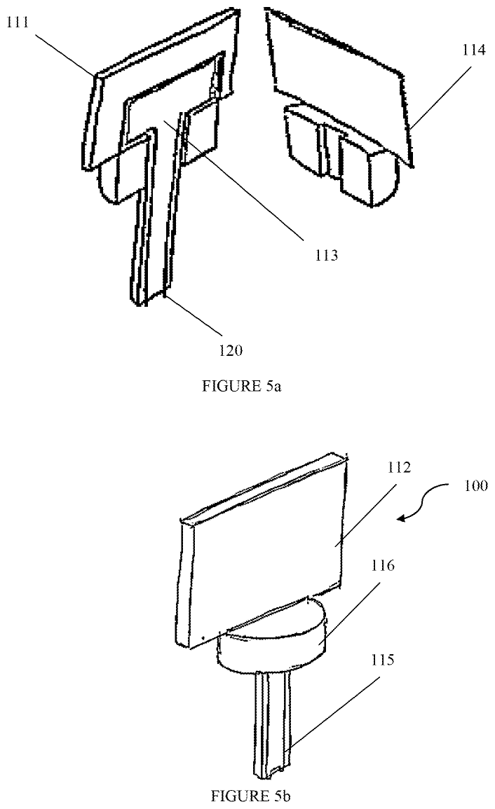

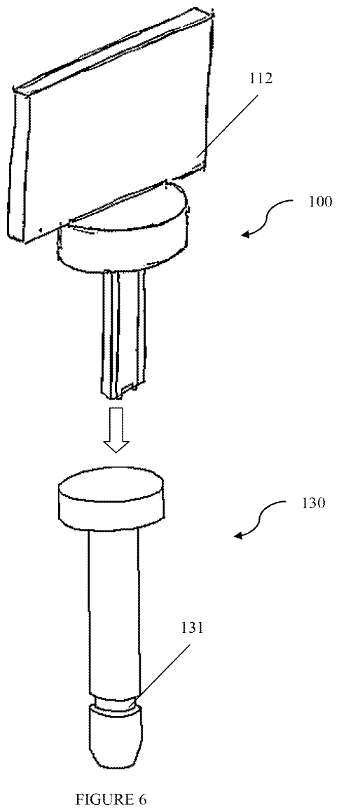

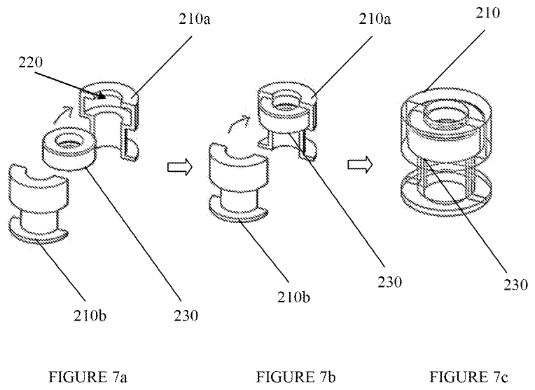

In an embodiment, the flag post 100 has a frame 110 which has a first panel 111 and a second panel 114, as shown in FIG. 5a, wherein the first panel 111 has a recess 113 for accommodating the circuit 120. The upper portion 112 of the frame 110 accommodates the antenna 122. The frame 110 has a portion, i.e., a pole 115 extending operatively downwards. The recess 113 extends through the pole portion. The pole 115 is inserted in a barrel 130, as shown in FIG. 6, wherein the barrel 130 is provided with a groove 131 provided at the free end of the barrel 130. The barrel 130 is further enclosed in an over mold 140 to securely hold the two parts together. Conducting elements 123 extend through the pole 115 to make the pair of terminals 124 protrude and remain exposed out of the pole 115 of the flag post 100, as shown in FIGS. 2, 3b, 4a. A shoulder 116 is configured to rest on a surface of the arrangement to be sealed. The pedestal 200 comprises a pedestal housing 210 having two halves 210a, 210b, as shown in FIGS. 7a, 7b. Both halves 210a, 210b are ultrasonically welded together sandwiching the circuit 120 in between. The housing 210 has an opening at the operative top for receiving the flag post 100. The housing 210 has a cavity 220 formed in its operative top half for housing a locking ring 230. The locking ring 230 is configured to engage with the groove 131 of the flag post 100 to ensure mechanical locking between the flag post 100 and the pedestal 200.

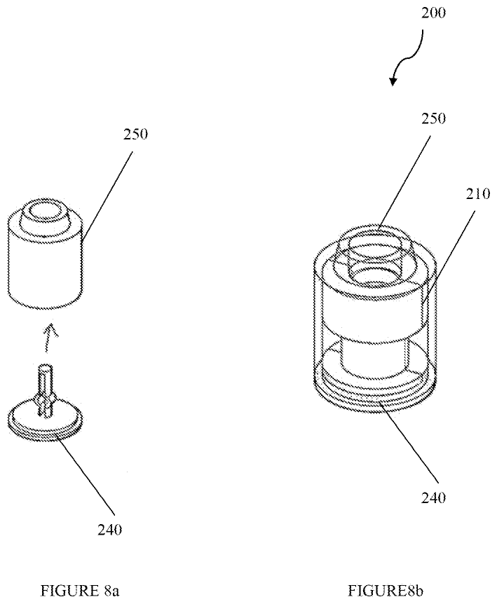

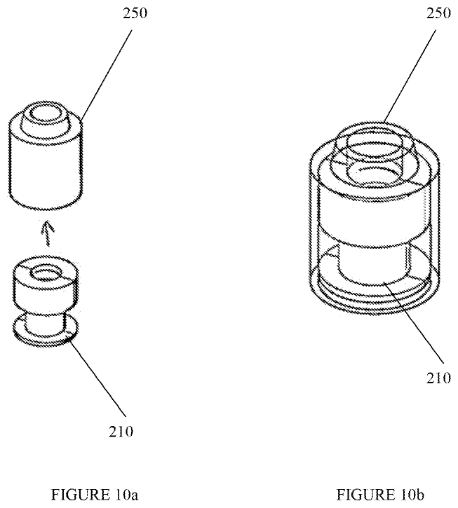

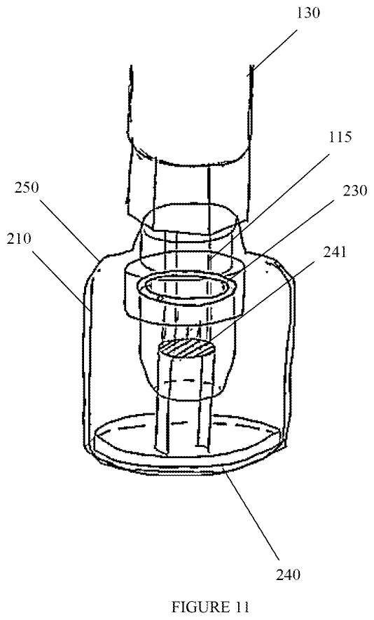

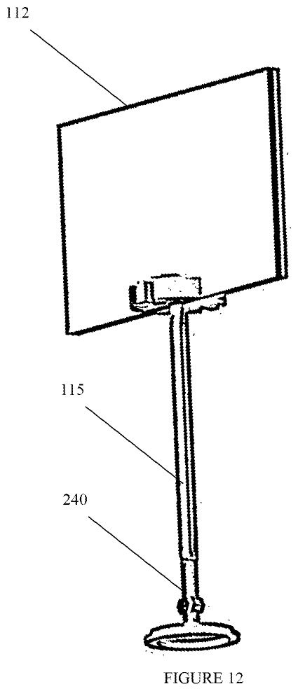

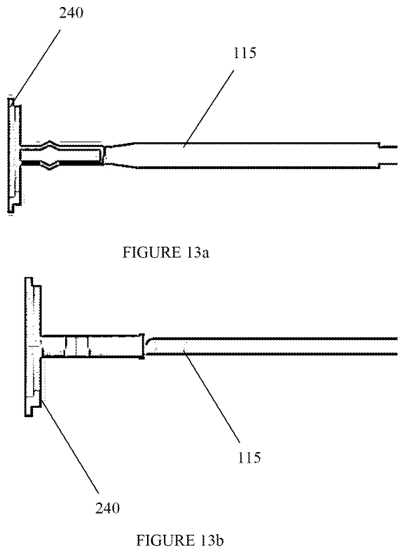

The operative lower end of the pedestal housing 210 is open for receiving a bottom cover 240, as shown in FIGS. 8a, 8b which is ultrasonically welded at the bottom periphery of the housing 210. The bottom cover 240, shown in FIG. 8, has a sticker mount 242 configured to allow sticking of a conductive sticker 241 made of frangible conductive film material. The conductive sticker 241 may also have a layer of an adhesive material on its operative top surface. The housing 210 thus assembled with the locking ring 230 and the bottom cover 240, is inserted in a jacket 250, as shown in FIGS. 10a, 10b, which is open at its operative top and bottom ends. According to an aspect of the present disclosure, the conductive sticker 241 stuck inside the housing 210 of the pedestal 200 is disposed at a height at which the pair of terminals 124 of the circuit 120 in the flag post 100 come in contact therewith, in a state of locking of the flag post 100 with the pedestal 200, as shown in FIG. 11. On contacting the conductive sticker 241, the terminals 124 stick to the conductive sticker 241 due to the adhesive layer present thereon. The conductive sticker 241 forms a tamper loop with the tamper detection chip 121 and the conducting elements 123 extending up to the terminals 124 by electrically coupling the terminals 124, as shown in FIGS. 12, 13a, 13b. In an event of tampering of the tamper-evident seal assembly 300, the conductive sticker 241 gets damaged and the loop is opened irreversibly.

In an embodiment, the sticker mount 242 has two legs, wherein the legs are compressible due to the pressure exerted for locking of the flag post 100 into the pedestal 200, particularly for snapping of the groove 131 over the locking ring 230, thus preventing inadvertent damage to the conductive sticker 241 by compensating for any additional pressure exerted during the snap-locking action of the flag post 100 into the pedestal 200. The working of the circuit 120 for tamper detection shall be explained here forth. The default count value stored in the counter is “0”.

In an embodiment, when the tamper loop is closed, i.e. when the flag post 100 is locked with the pedestal 200, the battery drives a current through the tamper loop defined by the tamper detection chip 121, the conducting wires extending up to the terminals 124 and the conductive sticker 241, and supplies power to the control unit of the tamper detection chip. Upon receiving the power, the control unit is configured to generate a closed event signal, and further to transmit the closed event signal to the tamper switch.

The tamper switch is configured to change state upon receiving the closed event signal. The change in state of the tamper switch drives the counter to increase the count value by one. When the tamper loop is opened, i.e. when the flag post 100 is removed (unlocked) from the pedestal 200, there will be no current in the tamper loop. In case of any pre- or post-tampering attempt, it is not possible to bypass the counter. If the tamper-evident seal assembly 300 is tampered by opening the tamper loop, the counter immediately increments the count. If the tamper loop is successfully reattached, the counter still increments count. Thus, the tamper detection chip 121 updates the tamper check flag in the tamper check flag register even in the absence of the field generated by an external electromagnetic reader. When this condition is detected by an electromagnetic reader, the tamper-evident seal assembly 300 is declared as tampered.

In another embodiment, the tamper-evident seal assembly 300 can use a chip which uses an RF field to check the tamper status. In this embodiment, a battery or capacitor is not required. In this embodiment, the seal can not detect a tamper attempt in the absence of an RF field. The chip can change its status to tampered only once and permanently if it is read once the seal is unlocked or tampered.

In another embodiment, the flag post 100 is inserted into the pedestal 200 till the locking ring 110 engages on the locking groove provided over the bottom cover 150. This ensures contact of the conductive sticker 151 with the two ends. Once the sticker bonds to the end of the loop, any attempt to forcibly disengage the two parts 100, 200 will damage the tamper loop beyond repair. The foregoing description of the embodiments has been provided for purposes of illustration and not intended to limit the scope of the present disclosure. Individual components of a particular embodiment are generally not limited to that particular embodiment, but are interchangeable. Such variations are not to be regarded as a departure from the present disclosure, and all such modifications are considered to be within the scope of the present disclosure.

Tamper-evident seal 300 can be used to discourage tampering, since an attempt to forcibly open the seal will damage the tamper loop beyond repair. Tamper-evident seal 300 updates the tamper check flag even in the absence of the field generated by an external electromagnetic reader.

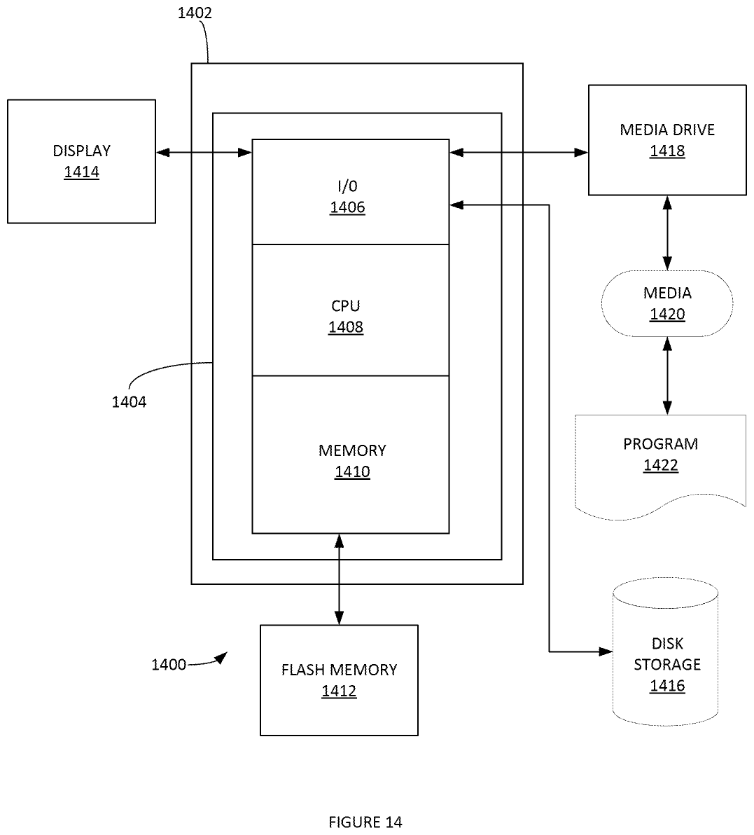

FIG. 14 depicts an exemplary computing system 1400 that can be configured to perform any one of the processes provided herein. In this context, computing system 1400 may include, for example, a processor, memory, storage, and I/O devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 14 depicts computing system 1400 with a number of components that may be used to perform any of the processes described herein. The main system 1402 includes a motherboard 1404 having an I/O section 1406, one or more central processing units (CPU) 1408, and a memory section 1410, which may have a flash memory card 1412 related to it. The I/O section 1406 can be connected to a display 1414, a keyboard and/or other user input (not shown), a disk storage unit 1416, and a media drive unit 1418. The media drive unit 1418 can read/write a computer-readable medium 1420, which can contain programs 1422 and/or data. Computing system 1400 can include a web browser. Moreover, it is noted that computing system 1400 can be configured to include additional systems in order to fulfill various functionalities. Computing system 1400 can communicate with other computing devices based on various computer communication protocols such a LoRaWAN, Wi-Fi, Bluetooth® (and/or other standards for exchanging data over short distances includes those using short-wavelength radio transmissions), USB, Ethernet, cellular, an ultrasonic local area communication protocol, etc.

### EXAMPLE METHODS

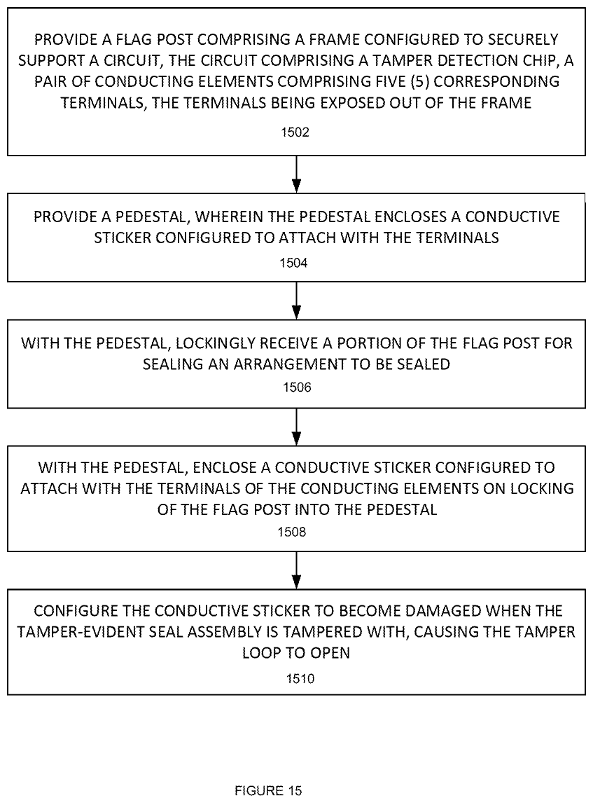

FIG. 15 illustrates an example process 1500 for operating a tamper-evident seal assembly, according to some embodiments. In step 1502, process 1500 provides a flag post comprising a frame configured to securely support a circuit, the circuit comprising a tamper detection chip, a pair of conducting elements comprising two (2) corresponding terminals, the terminals being exposed out of the frame. In step 1504, process 1500 provides a pedestal. In step 1506, with the pedestal, process 1500 encloses a conductive sticker configured to attach with the terminals. with the pedestal, lockingly receiving a portion of the flag post for sealing an arrangement to be sealed. In step 1508, with the pedestal, process 1500 encloses a conductive sticker configured to attach with the terminals of the conducting elements on locking of the flag post into the pedestal. In step 1510, process 1500 configures the conductive sticker to become damaged when the tamper-evident seal assembly is tampered with, causing the tamper loop to open.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A tamper-evident seal assembly comprising:
a flag post comprising:
a frame configured to securely support a circuit, the circuit comprising a tamper detection chip, a pair of conducting elements comprising two (2) corresponding terminals, the terminals being exposed out of the frame,
a pedestal configured to lockingly receive a portion of the flag post for sealing an arrangement to be sealed, wherein the pedestal encloses a conducting element configured to attach with the terminals of the conducting elements on locking of the flag post into the pedestal, thereby forming an electrical tamper loop with the tamper detection chip, and wherein the conducting element is configured to become damaged when the tamper-evident seal assembly is tampered with, causing the tamper loop to open.

2. The tamper-evident seal assembly of claim 1, wherein there is a snap-locking arrangement defined the flag post and the pedestal have a snap-locking arrangement.

3. The tamper-evident seal assembly of claim 2, wherein the frame of the flag post has a groove and the pedestal encloses a locking ring.

4. The tamper-evident seal assembly of claim 3, wherein the locking ring configured to snap-lockingly engage with the groove.

5. The tamper-evident seal assembly of claim 4, wherein the frame comprises two panels which are ultrasonically welded together.

6. The tamper-evident seal assembly of claim 5, wherein, wherein the circuit comprises an electrical energy storage device.

7. The tamper-evident seal assembly of claim 6, wherein the tamper detection chip is configured to receive electrical energy from the electrical energy storage device.

8. The tamper-evident seal assembly of claim 7, wherein the tamper detection chip comprises an electronic memory.

9. The tamper-evident seal assembly of claim 8, wherein the tamper detection chip is configured to irreversibly update information stored within the electronic memory when the tamper loop is opened.

10. The tamper-evident seal assembly of claim 9, wherein the antenna is configured to transmit information stored within the electronic memory on being energized electromagnetically by an electromagnetic reader.

11. The tamper-evident seal assembly of claim 10, wherein the circuit comprises at least one antenna which is configured to transmit information stored within the electronic memory on being energized electromagnetically by an electromagnetic reader.

12. The tamper-evident seal assembly of claim 11, wherein the tamper detection chip is a Radio-frequency identification (RFID) chip.

13. The tamper-evident seal assembly of claim 11, wherein the tamper detection chip a Near-Field Communication (NFC) chip.

14. The tamper-evident seal assembly of claim 13, wherein the conducting element comprises a conductive sticker.

15. A method of operating a tamper-evident seal assembly comprising:
providing a flag post comprising a frame configured to securely support a circuit, the circuit comprising a tamper detection chip, a pair of conducting elements comprising two (2) corresponding terminals, the terminals being exposed out of the frame;
providing a pedestal, wherein the pedestal encloses a conductive sticker configured to attach with the terminals;
with the pedestal, lockingly receiving a portion of the flag post for sealing an arrangement to be sealed;
with the pedestal, enclosing a conductive sticker configured to attach with the terminals of the conducting elements on locking of the flag post into the pedestal; and
configuring the conductive sticker to become damaged when the tamper-evident seal assembly is tampered with, causing the tamper loop to open.

16. The method of claim 15, wherein the conducting element comprises a conductive sticker.
